(19) United States
(12) Patent Application Publication
(10) Pub. No.: US 2012/0284647 A1
(43) Pub. Date: Nov. 8, 2012

(54) COLLABORATIVE INPUT SYSTEM

(75) Inventors: Simon FRADKIN, Blackburn (GB); David HARRISON, Blackburn (GB)

(73) Assignee: PROMETHEAN LIMITED, Lancashire (GB)

(21) Appl. No.: 13/288,569

(22) Filed: Nov. 3, 2011

(30) Foreign Application Priority Data
Nov. 5, 2010 (GB) 1018770.6

(51) Int. Cl. G06F 3/01; G06F 15/16

(52) U.S. Cl. 715/753

(57) ABSTRACT

A method in a collaborative input system comprises a computer system, a display associated with the computer system, and a plurality of remote terminals each associated with one of a respective plurality of users and each having a display. The plurality of remote terminals are in communication with the computer system. The method comprises: displaying, on the display, a seed word; transmitting a request for a word from the computer to each of the remote terminals; at each of the remote terminals, prompting the respective user to enter a word by displaying a request for data entry; receiving, at at least one of the remote terminals, a word entered by a user; transmitting the entered word from the at least one of remote terminals to the computer; and displaying each word received from a remote terminal on the display in association with the seed word.

### BACKGROUND TO THE INVENTION

1. Field of the Invention

The present invention relates to an improved user interface, and particularly to a user interface adapted to receive inputs from a plurality of user input devices. The invention is particularly, but not exclusively concerned with an improvement to a user interface in an interactive display system comprising an interactive display surface.

2. Description of the Related Art

Interactive display systems are well-known. In an interactive display system, a user (or users) interact with an interactive display surface on which an image is projected. In one known environment, the interactive display surface may be a display surface of an electronic whiteboard, which is used in a classroom environment for educational purposes.

In such systems, the user (or users) stand at or close to the display surface, and interact with the display surface. Different types of interactive display surface are possible, and the user may interact with the surface by using a finger in a touch-sensitive system, or by using a pointer device such as in an electromagnetic interactive display surface. Other technologies, such as camera-based position detection, may also be used.

In such systems, the use of the pointer (or finger) at the interactive display surface may be for the same purpose as a mouse in a desktop computer system. The user uses the pointer to control a cursor displayed on the display screen, and to select icons and tools displayed on the display screen. In this way the user can manipulate the information displayed in the same manner as they may manipulate information using a desktop computer, but the manipulation takes place at the display on which information is displayed to a classroom. In this way the display is an electronic whiteboard.

It is also known in the art to provide such interactive display systems with a plurality of additional input devices. In a typical educational environment, where the display is visible to a plurality of students, the students may be equipped with individual input devices. The input devices allow the individual students to collaborate in exercises conducted using the interactive display, by providing inputs by an alternate means. In known interactive display systems such input devices provided to the students interact wirelessly with the main interactive display system. The input devices may be used, for example, for students to provide answers to multiple choice questions displayed on the whiteboard screen. Interactive display systems with the provision of such multiple input devices are typically known as learner response systems.

It is generally an aim in the use of interactive whiteboard systems, particularly in educational environments, to maximise the interaction of students with an exercise being run in conjunction with the interactive display system. The use of the input devices provided to students assist in this.

It is an object of the invention to provide improved interaction with the interactive display system in conjunction with user inputs other than at the interactive surface itself, particularly for students with an exercise being carried out using the interactive display system.

### SUMMARY OF THE INVENTION

There is provided a method in a collaborative input system comprising a computer system, a display associated with the computer system, and a plurality of remote terminals each associated with one of a respective plurality of users and each having a display, the plurality of remote terminals each being in communication with the computer system, the method comprising: displaying, on the display, a seed word; transmitting a request for a word from the computer to each of the plurality of remote terminals; at each of the plurality of remote terminals, prompting the respective user to enter a word by displaying a request for data entry; receiving, at at least one of the plurality of remote terminals, a word entered by a user; transmitting the entered word from the at least one of the plurality of remote terminals to the computer; and displaying each word received from a remote terminal on the display in association with the seed word.

The method may further comprise the step of entering the seed word at the computer.

The step of transmitting a request for a word from the computer to each of the plurality of remote terminals may comprise transmitting an instruction to display a template stored on each of the remote terminals on the display of each remote terminal.

The step of, at each of the plurality of remote terminals, prompting the respective user to enter a word by displaying a request for data entry may comprise displaying the stored template.

The step of receiving, at at least one of the plurality of remote terminals, a word entered by a user may comprise detecting an input entered on a keypad of the remote terminal.

The step of displaying each word received from a remote terminal on the display in association with the seed word may comprise determining if the same word is received from more than one remote terminal, and in determination of such displaying such word only once.

The method may further comprise the step of displaying with such displayed word, and indication of the number of times the same word was received.

The method may further comprise displaying with each word the identity of the user associated with the remote terminal from which such word was received.

The method may further comprise the step of indicating the association between the displayed received words and the seed word by displaying the played received words and the seed word with a common appearance.

The method may further comprise the step of displaying a connector between the seed word and each displayed received word.

A computer program may be adapted, when run on a computer, to perform any defined method. A computer program product may be provided for storing computer program code which, when run on a computer, performs any defined method.

The invention further provides a collaborative input system comprising a computer system, a display associated with the computer system, and a plurality of remote terminals each associated with one of a respective plurality of users and each having a display, the plurality of remote terminals each being in communication with the computer system, the collaborative input system being adapted to: display, on the display, a seed word; transmit a request for a word from the computer to each of the plurality of remote terminals; at each of the plurality of remote terminals, prompt the respective user to enter a word by displaying a request for data entry; receive, at at least one of the plurality of remote terminals, a word entered by a user; transmit the entered word from the at least one of the plurality of remote terminals to the computer; and display each word received from a remote terminal on the display in association with the seed word.

The collaborative input system may further be adapted to enter the seed word at the computer.

The collaborative input system may further be adapted to transmit a request for a word from the computer to each of the plurality of remote terminals by transmitting an instruction to display a template stored on each of the remote terminals on the display of each remote terminal.

The collaborative input system may further be adapted to, at each of the plurality of remote terminals, prompt the respective user to enter a word by displaying a request for data entry comprises displaying the stored template.

The collaborative input system may be further adapted such that, at at least one of the plurality of remote terminals, a word entered by a user comprises detecting an input entered on a keypad of the remote terminal.

The collaborative input system may further be adapted such as to display each word received from a remote terminal on the display in association with the seed word comprises determining if the same word is received from more than one remote terminal, and in determination of such displaying such word only once.

The collaborative input system may further be adapted to display with such displayed word, an indication of the number of times the same word was received.

The collaborative input system may further be adapted to display with each word the identity of the user associated with the remote terminal from which such word was received.

The collaborative input system may further be adapted to indicate the association between the displayed received words and the seed word by displaying the played received words and the seed word with a common appearance.

The collaborative input system of may further be adapted to display a connector between the seed word and each displayed received word.

### BRIEF DESCRIPTION OF THE FIGURES

The invention will now be described by way of example with reference to the accompanying figures, in which:

FIG. 1 illustrates a typical environment for an interactive display system, including an interactive display and a plurality of user input devices;

FIG. 2 illustrates a typical interactive display system including an electronic whiteboard incorporating an interactive display surface;

FIG. 3 illustrates a further example of a typical interactive display system, comprising a conventional computer system;

FIG. 4 illustrates a display on a user interface in accordance with an embodiment of the invention;

FIG. 5 illustrates an adaptation of the display of FIG. 4 in accordance with an embodiment of the invention; and

FIG. 6 illustrates an adaptation of the display of FIG. 4 or FIG. 5 in accordance with an embodiment of the invention.

### DESCRIPTION OF THE PREFERRED EMBODIMENTS

The invention is described herein by way of reference to specific preferred embodiments and implementations. One skilled in the art will appreciate that the invention is not limited to the specifics of any arrangement described herein. In particular the invention is described herein particularly in the context of an exemplary interactive display system, and one skilled in the art will appreciate that the invention is not limited to the specifics of the described interactive display system, or indeed to an interactive display system with an interactive display surface. The invention is generally advantageously applicable to any environment where a plurality of user input devices are in communication with a display.

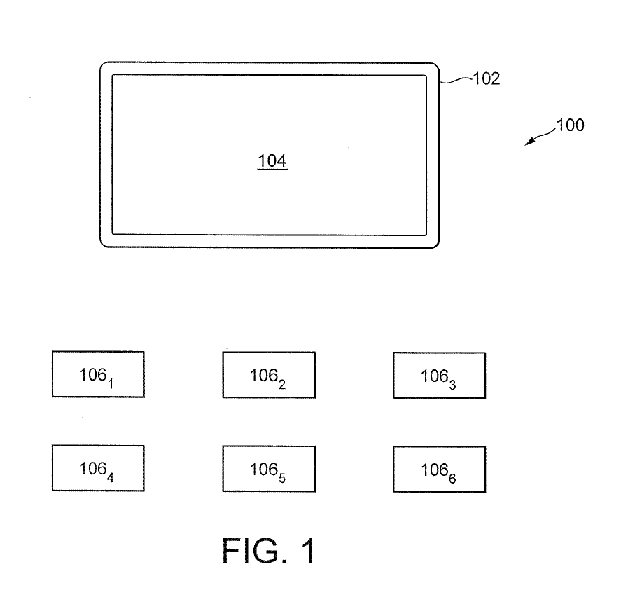

With reference to FIG. 1 there is generally illustrated a display environment 100 within which the invention and embodiments thereof may be implemented. The display environment 100 includes a display 102 having a display screen or surface 104. Associated with the display 102 is a plurality of input devices 106. In the example of FIG. 1 there is illustrated six input device 106, denoted by reference numerals 106₁ to 106₆. The input devices 106₁ to 106₆ are adapted to communicate with the display device 102, such that there is an interaction between information displayed on the display screen 104 and the input devices. The communication between the input devices 106₁ to 106₆ and the display device 102 may be by way of a plurality of means, such as by virtue of interconnection with a computer system associated with the display 102, with wireless interconnection taking place between the input devices 106₁ to 106₆ and the display 102 via the computer system.

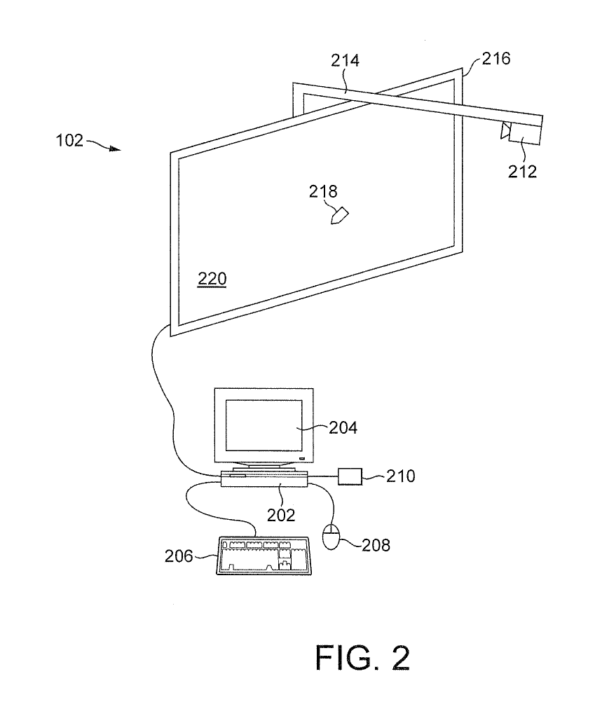

In a preferred implementation the display 102 is part of an interactive display system, an exemplary implementation of which is illustrated in FIG. 2. In FIG. 2 the display comprises an interactive whiteboard generally denoted by reference numeral 216. The interactive whiteboard 216 is associated with a boom arm 214 which extends perpendicularly away from the whiteboard to provide a support for a projector 212. As known in the art the projector 212 projects images onto the interactive whiteboard 216. The interactive whiteboard 216 is connected to a computer 202, having a display screen 204, a keyboard input device 206, and a mouse input device 208. Also shown in FIG. 2 is a wireless device 210 associated with the computer 202. In a preferred embodiment the wireless device 210 provides for wireless communication between the computer 202 and the input devices 106₁ to 106₆ of FIG. 1. The computer 202 also has an input connection to the projector 212 (not shown). As known in the art, the computer 202 generates graphical images for display on the display surface 220 of the electronic whiteboard 216 using the projector 212. The display surface 220 of the electronic whiteboard 216 is adapted to detect the presence of a pointing device, such as a pointer 218, at the surface 220, to detect the position of such, and to adapt the displayed image accordingly. The pointer 218 in effect acts as a mouse of the computer system. Although the arrangement of FIG. 2 illustrates an interactive display surface 220 which is responsive to a pointing device 218, such as may be provided in an electromagnetic arrangement, other interactive display systems allow for the implementation of an interactive arrangement using alternative technologies, such as touch-sensitive technologies. Embodiments of the invention relating to interactive displays are not limited to any specific interactive surface technology. The pointing device, whether a pen or finger, may be considered a system input device.

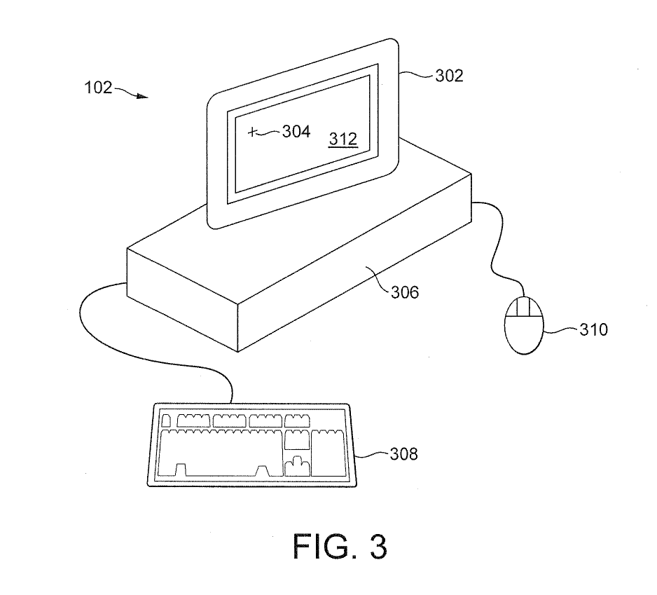

Whilst the invention is described herein particularly in relation to an interactive whiteboard system, the invention is not limited to such an arrangement. The invention, in general, is applicable to any arrangement in which a display is provided to display images, and in which there is provided a plurality of input devices each of which may provide an input to affect the displayed images. As illustrated in FIG. 3, the displayed images may be displayed by a display 302 of a conventional computer system 306, the display 302 having a display surface 312. The conventional computer system 306 is provided with a keyboard input device 308 and a mouse input device 310. As known in the art, a cursor 304 is displayed on the display screen 312, under control of the mouse 310. The computer system 306 may also be adapted to communicate, preferably wirelessly, with the input devices 106₁ to 106₆ of FIG. 1.

It should be noted that in the arrangement of FIG. 2, the keyboard input device 206 and mouse input device 208 of the computer 202 may also control the displayed images on the display surface 220. The mouse may be considered a system input device. Thus a cursor such as cursor 304 of FIG. 3 may also be displayed on the display surface 220 of the electronic whiteboard 216 of FIG. 2.

In general, the invention is concerned with a display of a computer system, whether an interactive display surface or otherwise, which operates under the control of a computer system using a system input device, which computer system is further adapted to receive inputs from one or more of a plurality of user input devices under the control of the system input device.

The user input devices 106₁ to 106₆ are preferably, in any given implementation, identical. Each user input device 106₁ to 106₆ is preferably uniquely associated with a particular user (a particular student user) during an application session. The devices 106₁ to 106₆ may be graphic tablets, which allow the user to write on an interactive surface thereof in order to provide inputs to a computer system. The user input devices 106₁ to 106₆ may be devices provided with a keypad to allow users to input information to the computer system using keypad inputs. The user input devices 106₁ to 106₆ are preferably provided with a user display, in order to allow a user to view the inputs which they have entered, and also preferably to provide a template to limit the type or quantity of data which a user may input at any time.

The invention is described in the context of an application running on the computer system 202. The application is a word seed application. In a word seed application a seed word is displayed on the display 104, and then one or more additional words are entered for display based on their association with the seed word. The one or more additional words are therefore generated by one or more users, based on their viewing the displayed seed word, and based on their determination of a word they believed to be associated with the seed word.

Associated words may be entered by a user providing an input directly at the display surface 104. However in accordance with the principles of the invention associated words are provided by users associated with the input devices 106, and the associated words are displayed on the display 104 in a relationship with the seed word on receipt of data at the computer system from the input devices 106.

With a number of user input devices 106 registered with the computer system 202, a note can be selected from t application, which displays a menu icon. Selecting the menu icon with, for example, a touch contact provided by a finger, displays a menu with an item called “Start Word Seed”.

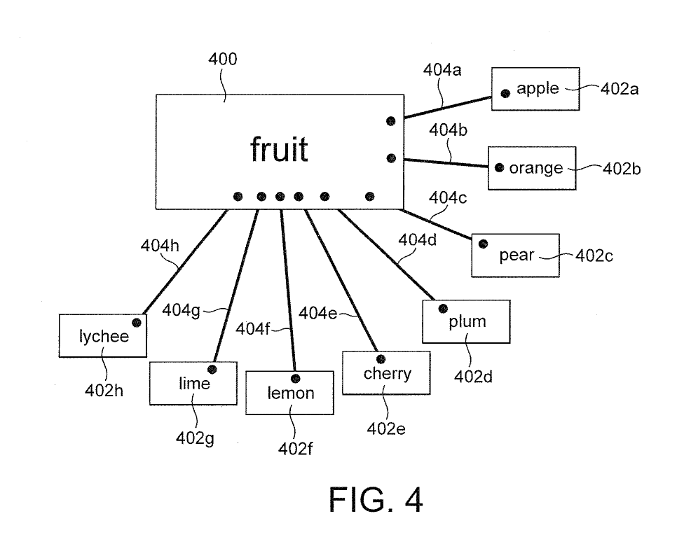

As a result, a seed word is displayed on the display surface 104. As illustrated in the example of FIG. 4, a seed word “fruit” is displayed as an icon 400 on the display 104, and a word seed session commences.

On displaying the seed word “fruit”, a signal is sent to each of the user input devices 106, to prompt each user to enter a word. Preferably the signal sent to the plurality of user input devices is an instruction to display on the display thereof a template of the type of data input which is required. Thus each user input device 106 may display a template to the respective user which only allows a text input to be made using the user input device 106.

Responsive to the prompt at the respective devices, each user enters a word based on an association they make following the display of the seed word. This word is then transmitted, preferably to the computer 202. The words may be transmitted from the user input devices to the computer responsive to a request from the computer, or responsive to selection of an option at the user input device to indicate confirmation of a word entry.

On receipt of associated words from the user input devices, the words are displayed on the display 104 under the control of the computer. The seeding note will display a seeding icon.

As a submitted word is received by the application, it is used to create a new note with that word and with the colour of the initial note 400 that was used to start the seed. The new notes 402a to 402h are placed in a circle around the seeding note 400, each with a respective connector 404a to 404h joining the seeding note 400 with the seeded notes 402a to 402h.

If the circle is filled, new notes will once again circle the seeding note 400, but with a greater distance from the centre of the seeding note 400, to prevent note collisions.

An example of seeded notes 402a to 402h that show notes submitted when seeded from the note 400 entitled ‘fruit’ is illustrated in FIG. 4. These include notes with the words “apple”, “orange”, “pear”, “plum”, “cherry”, “lemon”, “lime”, and “lychee”.

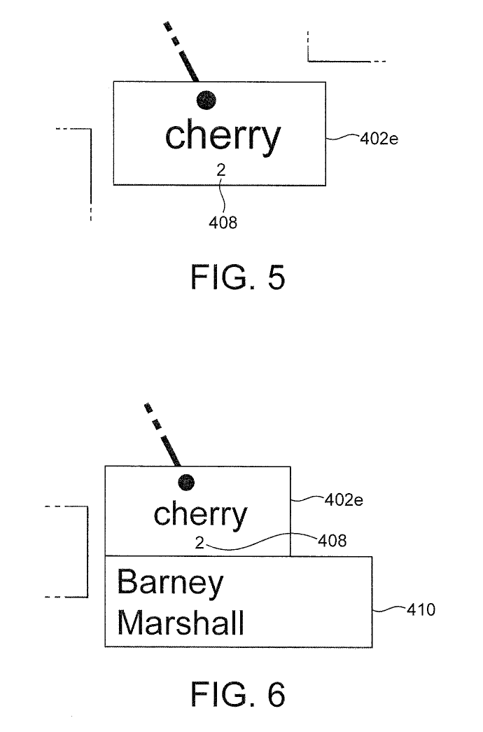

With reference to FIG. 5, if a seeded word that is received is a duplicate of a word already received in the session, a new seeding note will preferably not be created, but instead, the original seeded note will display the number of times the word has been seeded.

An examples demonstrating a note with duplicate content submitted by two people is illustrated in FIG. 5. As can be seen, the seeding note 402e is annotated with a number 408, which indicates how many times that selection of word has been made and received.

Seeding will stop when either all registered user input devices 106 have submitted a word, or an option “End Word Seed” is selected from the note's menu.

The menu of a seeded note may include an item entitled “Show Seeder Names”. When selected this will display the name(s) of those who submitted the seeded note. An example of a seeded note 402e displaying names of those who submitted the content for the note is illustrated in FIG. 6. As can be seen in FIG. 6, a display icon 410 is associated with the seeded note 402e, and includes two names: Barney and Marshall.

The methods described hereinabove may be implemented on computer software running on a computer system. The invention may therefore be embodied as a computer program code being executed under the control of a processor or a computer system. The computer program code may be stored on a computer program product. A computer program product may be included in a computer memory, a portable disk, or portable storage memory, or hard disk memory.

The invention and its embodiments are described herein in the context of application to an interactive display of an interactive display system. It will be understood by one skilled in the art that the principles of the invention, and its embodiments, are not limited to an interactive display surface. The principles of the invention and its embodiments may be implemented in any computer system including a display, a system input device, and a plurality of user input devices. The invention encompasses any technique for the movement of a user input position, whether by way of a pointer on an interactive display surface (such as a finger or pen), or by way of a conventional computer mouse.

The invention has been described herein by way of reference to particular examples and exemplary embodiments. One skilled in the art will appreciate that the invention is not limited to the details of the specific examples and exemplary embodiments set forth. Numerous other embodiments may be envisaged without departing from the scope of the invention, which is defined by the appended claims.

1. A method in a collaborative input system comprising a computer system, a display associated with the computer system, and a plurality of remote terminals each associated with one of a respective plurality of users and each having a display, the plurality of remote terminals each being in communication with the computer system, the method comprising:
displaying, on the display, a seed word;
transmitting a request for a word from the computer to each of the plurality of remote terminals;
at each of the plurality of remote terminals, prompting the respective user to enter a word by displaying a request for data entry;
receiving, at at least one of the plurality of remote terminals, a word entered by a user;
transmitting the entered word from the at least one of the plurality of remote terminals to the computer; and
displaying each word received from a remote terminal on the display in association with the seed word.

2. The method of claim 1 further comprising the step of entering the seed word at the computer.

3. The method of claim 1 wherein the step of transmitting a request for a word from the computer to each of the plurality of remote terminals comprised transmitting an instruction to display a template stored on each of the remote terminals on the display of each remote terminal.

4. The method of claim 1 wherein the step of, at each of the plurality of remote terminals, prompting the respective user to enter a word by displaying a request for data entry comprises displaying the stored template.

5. The method of claim 1 wherein the step of receiving, at at least one of the plurality of remote terminals, a word entered by a user comprises detecting an input entered on a keypad of the remote terminal.

6. The method of claim 1 wherein the step of displaying each word received from a remote terminal on the display in association with the seed word comprises determining if the same word is received from more than one remote terminal, and in determination of such displaying such word only once.

7. The method of claim 6 further comprising the step of displaying with such displayed word, and indication of the number of times the same word was received.

8. The method of claim 1 further comprising displaying with each word the identity of the user associated with the remote terminal from which such word was received.

9. The method of claim 1 further comprising the step of indicating the association between the displayed received words and the seed word by displaying the played received words and the seed word with a common appearance.

10. The method of claim 1 further comprising the step of displaying a connector between the seed word and each displayed received word.

11. A computer program adapted, when run on a computer, to perform the method of claim 1.

12. A computer program product for storing computer program code which, when run on a computer, performs the method of claim 1.

13. A collaborative input system comprising a computer system, a display associated with the computer system, and a plurality of remote terminals each associated with one of a respective plurality of users and each having a display, the plurality of remote terminals each being in communication with the computer system, the collaborative input system being adapted to:
display, on the display, a seed word;
transmit a request for a word from the computer to each of the plurality of remote terminals;
at each of the plurality of remote terminals, prompt the respective user to enter a word by displaying a request for data entry;
receive, at at least one of the plurality of remote terminals, a word entered by a user;
transmit the entered word from the at least one of the plurality of remote terminals to the computer; and
display each word received from a remote terminal on the display in association with the seed word.

14. The collaborative input system of claim 13 further adapted to enter the seed word at the computer.

15. The collaborative input system of claim 13 further adapted to transmit a request for a word from the computer to each of the plurality of remote terminals by transmitting an instruction to display a template stored on each of the remote terminals on the display of each remote terminal.

16. The collaborative input system of claim 13 further adapted to, at each of the plurality of remote terminals, prompt the respective user to enter a word by displaying a request for data entry comprises displaying the stored template.

17. The collaborative input system of claim 13 further adapted such that, at least one of the plurality of remote terminals, a word entered by a user comprises detecting an input entered on a keypad of the remote terminal.

18. The collaborative input system of claim 13 further adapted such as to display each word received from a remote terminal on the display in association with the seed word comprises determining if the same word is received from more than one remote terminal, and in determination of such displaying such word only once.

19. The collaborative input system of claim 18 further adapted to display with such displayed word, an indication of the number of times the same word was received.

20. The collaborative input system of claim 13 further adapted to display with each word the identity of the user associated with the remote terminal from which such word was received.
